(19) United States
(12) Patent Application Publication
(10) Pub. No.: US 2013/0100059 A1
(43) Pub. Date: Apr. 25, 2013

(54) CONTENT DISPLAY ENGINE FOR TOUCH-ENABLED DEVICES

(71) Applicant: Zuse, Inc., New York, NY (US)

(72) Inventors: David S. Champion, New York, NY (US); Gordon Chiu, New York, NY (US); Joel Milton, New York, NY (US)

(73) Assignee: Zuse, Inc., New York, NY (US)

(21) Appl. No.: 13/657,098

(22) Filed: Oct. 22, 2012

Related U.S. Application Data
(60) Provisional application No. 61/550,018, filed on Oct. 21, 2011.

(51) Int. Cl. G06F 3/041

(52) U.S. Cl. 345/173

(57) ABSTRACT

A touch-optimized user-interface is presented that uses a multi-touch surface and a display screen that simultaneously displays a non-overlapping array of web-tiles, each of which represents a different website. Screen-touch events are captured, recognized and interpreted as functions that are applied to one or more of the web-tiles. A virtual framework contains virtual web-tiles that are webpages filtered and rendered to an array of pixel positions and values. The virtual framework specifies the relative size and position of the web-tiles with respect to each other, and their absolute position and size with respect to currently displayed web-tiles. The web-tiles are displayed as arrays, each capable of being interacted with independently via the multi-touch screen. The user-interface has multiple interpretation modes, each of which interprets the same screen-touch events differently.

### CLAIM OF PRIORITY

This application claims priority to U.S. Ser. No. 61/550,018 filed Oct. 21, 2011, the contents of which are fully incorporated herein by reference.

### FIELD OF THE INVENTION

The invention relates to systems and methods for interfacing with computers, and more particularly, to systems and methods for searching, browsing and displaying hypertext content on touch enabled displays and devices.

### BACKGROUND OF THE INVENTION

Existing search engines and content display tools have typically been designed and optimized for use through a combination of a physical keyboard and a physical pointing devices such as, but not limited to, a mouse, that is used to move a pointer on the display screen.

Touch-enabled display devices have become increasingly popular as evidenced by the rapid commercial success of smart phones, tablets and e-readers. With these, a user may display and search content using a combination of direct touch, touch gestures and virtual keyboards, without the need for physical devices or physical pointing devices.

The underlying architecture controlling the user interface on touch-enabled devices, however, remains rooted in largely obsolete assumptions that are a legacy of the time when physical pointer devices and physical keyboards where the primary means of interfacing with content devices.

One example of the limitations of legacy interface architectures is that the focus, or attention, of the system can only be on one display window at a time. This may be satisfactory, probably even necessary, when there is only one cursor that may be controlled. A touch screen interface, however, particularly a multi-touch enabled screen, opens up significantly greater possibilities. A multi-touch device may, for instance, have multi-window focus in which several different data streams may be interacted with simultaneously by using multiple “virtual cursors”, a.k.a. multiple fingers.

An objective of the present invention is a novel user interface architecture and implementation that may allow fuller use of such hitherto ignored possibilities of multi-touch devices, and provide a user with a more efficient and effective method of interacting with information, including, but not limited to, improved searching and content display.

It is a further objective of the invention to provide a user interface that elevates a user's interactive experience in preparation for future, even more evolved and capable touch screens that may mimic a sheet of paper.

1. Description of the Related Art

The relevant prior art includes:

U.S. Pat. No. 7,688,312 issued to Hinckley, et al. on Mar. 30, 2010 entitled “Touch-sensitive device for scrolling a document on a display” that describes a touch-sensitive device used as an electronic input device for controlling the visible portion of a document or image relative to a display. The device can include various improved configurations such as physically separate, opposed input, surfaces at opposite longitudinal ends and/or lateral sides. The end regions of a touch sensitive surface may be rounded and/or tapered to provide relative positional feedback to the user. Tactile positional feedback can also include surface texture changes on the scrolling area and/or changes in the surface of the frame in the region immediately adjacent the scrolling area. The touch sensitive areas may be provided within a split alphanumeric section of an ergonomic keyboard to enable scrolling without the user having to remove his or her hands from the alphanumeric section.

U.S. Pat. No. 8,264,455 issued to Fiebrink, et al. on Sep. 11, 2012 entitled “Mapping of physical controls for surface computing” that describes physical controls on a physical controller device (PCD) being dynamically mapped to application controls for an application being executed on a computer having a touch-sensitive display surface. The computer identifies a PCD which has been placed by a user on the display surface and displays a mapping aura for the PCD. When the user touches an activate direct-touch button displayed within the mapping aura, the computer activates a mapping procedure for the PCD and displays a highlighted direct-touch button over each application control which is available to be mapped to the physical controls on the PCD. When the user selects a particular application control which is available to be mapped by touching the highlighted button residing over the control, the computer creates a dynamic mapping between the selected application control and a user-selected physical control on the PCD.

U.S. Pat. No. 7,979,809 issued to Sunday on Jul. 12, 2011 entitled “Gestured movement of object to display edge” that describes the use of gestures to organize displayed objects on an interactive display. The gesture is used to move the displayed object to the edge of the interactive display so that the displayed object is only partially displayed after being moved. The size of the displayed object may be reduced and/or the displayed object may be rotated such that an identified portion of the displayed object remains in the display after moving. A gesture may also be used to move multiple displayed objects to the edge of the display.

US Patent Application 20100031203 issued to Morris; Meredith J.; et al. on Feb. 4, 2010 entitled “User-defined Gesture Set for Surface Computing” “ that describes a system and/or a method that facilitates generating an intuitive set of gestures for employment with surface computing. A gesture set creator can prompt two or more users with a potential effect for a portion of displayed data. An interface component can receive at least one surface input from the user in response to the prompted potential effect. A surface detection component can track the surface input utilizing a computer vision-based sensing technique. The gesture set creator collects the surface input from the two or more users in order to identify a user-defined gesture based upon a correlation between the respective surface inputs, wherein the user-defined gesture is defined as an input that initiates the potential effect for the portion of displayed data.

Various implements are known in the art, but fail to address all of the problems solved by the invention described herein. Various embodiments of this invention are illustrated in the accompanying drawings and will be described in more detail herein below.

### SUMMARY OF THE INVENTION

The present invention relates to systems, architectures and implementations of multi-touch, user-interfaces.

In a preferred embodiment, the multi-touch user-interface may include a 2-D image display and a functionally connected, 2-D multi-touch sensing surface, such as, but not limited to, a transparent multi-touch surface overlaying a color display screen.

A digital data-processor may be functionally connected to both the image display and the multi-touch-sensing surface. The data processor may, for instance, be programed via a set of instructions and so may provide functionality such as, but not limited to, that described below.

The data-processor, may, for instance, maintain a virtual framework that includes a relative position and size of one or virtual web-tiles. Virtual web-tiles may, for instance, be software constructs that may represent a color and an intensity of each of an array of pixels.

In a preferred embodiment, a hypertext webpage may be downloaded via a data network, such as the World Wide Web on the Internet. The webpage may be filtered and then rendered to one of the virtual web-tiles. Using a display-map, i.e., instructions that may map virtual web-tiles to physical pixels on the 2-D image display, a web-tile may be displayed on the 2-D display showing the rendered, filtered-webpage.

The multi-touch surface may then capture a screen-touch event. Using a screen-map, i.e., instructions mapping a position on the touch screen to a current position of the virtual framework, the data processor may interpret the user-screen interaction, and respond to the interpreted type of screen-touch event by altering the display of the web-tiles by, for instance, altering their appearance, their position, their size or some combination thereof.

A one-finger glide, may for instance, result in a corresponding alteration of the position of the web-tile currently shown on the display screen at the position of the glide.

In a further preferred embodiment of the invention, the virtual framework may have two or more virtual web-tiles that may be mapped to adjacent rectangular arrays of pixels. Separate webpages, possibly from separate websites, may be rendered to each virtual web-tile. The web-tiles may then all be simultaneously displayed on the 2-D display in the same relative positions and sizes as in the virtual framework. They may, for instance, be displayed as arrays of 1, 2, 4, 8 or more web-tiles, each representing a different webpage, and each capable of being interacted with via the multi-touch screen.

Screen-touch events that may be captured, recognized and interpreted as user instructions include events such as, but not limited to, one finger tapping, long touching, glide and swiping, and two finger taping, two finger long touching, pinching, spreading, swiping and rotating, or some combination thereof. Each of these events may correspond to an appropriate function to be applied to one or more of the displayed web-tiles.

In a preferred embodiment, the system may have multiple modes, and screen-touch events may be interpreted differently in each mode. For instance, in a first mode a one finger swipe may be interpreted as an instruction to scroll through the contents being displayed in one of several web-tiles on display. In a second mode, that same one finger swipe may now be interpreted as an instruction to pan all the currently displayed web-tiles in the direction of the swipe.

Other innovations of a preferred embodiment include, but are not limited to, displaying an array or ribbon of icon tiles, each indicative of an uniform resource locator (URL). The ribbon may, for instance, be scrolled through using a one finger swipe, and then a long touch on an icon, followed by a one-finger swipe to a location of a displayed web-tile may result in the webpage corresponding to that URL being obtained, filtered, rendered and then displayed in that web-tile. Or a link displayed in one web-tile may be dragged to another web-tile.

There may also be an array of action buttons that may be used, for instance, to invoke a virtual keyboard for text search input, or to invoke an action icon such as, but not limited to, a quick zoom icon.

Therefore, the present invention succeeds in conferring the following, and others not mentioned, desirable and useful benefits and objectives.

It is an object of the present invention to provide a user interface optimized for use on a touch screen.

It is another object of the present invention to provide a rapid and intuitive means of searching the internet using a multi-touch screen associated with a display.

Yet another object of the present invention is to provide a navigation interface that is independent of external, peripheral devices.

It is yet another object of the present invention to provide a rapid and intuitive means of allocating specific content from within any given webpage for immediate sharing to an online network and/or individual connection through one or more of the numerous online social networking websites, wherein previous inventions of similar intent have only enabled the allocation of an entire webpage for sharing through any given sharing function

### BRIEF DESCRIPTION OF THE DRAWINGS

FIG. 1 shows a multi-touch user interface of a preferred embodiment of the present invention.

FIG. 2 shows a flow diagram depicting certain functional steps of a multi-touch user interface of a preferred embodiment of the present invention.

FIG. 3 shows a multi-touch user interface of a further preferred embodiment of the present invention.

FIG. 4 shows an exemplary screen layout of a multi-touch user interface of the present invention.

FIG. 5 shows a further exemplary screen layout of a multi-touch user interface of the present invention.

FIG. 6 shows yet a further exemplary screen layout of a multi-touch user interface of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

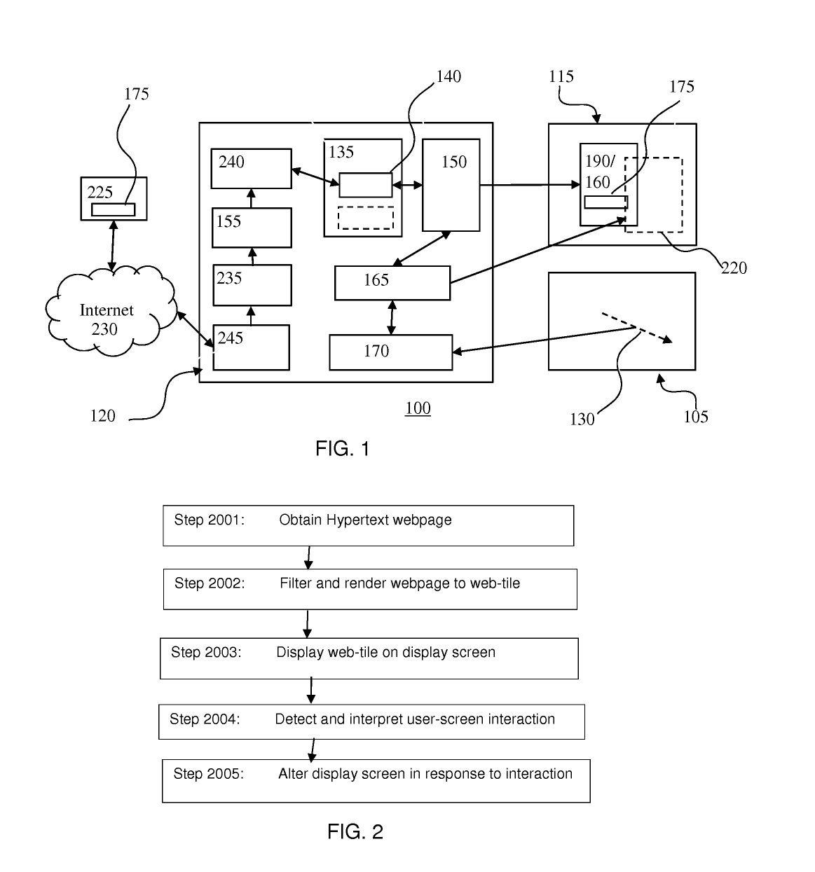

FIG. 1 shows a multi-touch user interface of a preferred embodiment of the present invention. In a preferred embodiment, the multi-touch user interface 100 may include a 2-D image display 115, a 2-D multi-touch-sensing surface 105 and a suitably programed digital data processor 120. The combination may, for instance, be an electronics communications device such as, but not limited to, a tablet, a smart phone, a notebook computer, an e-reader or some combination thereof, with the digital data processor 120 being in function control of the 2-D image display 115 and the 2-D multi-touch-sensing surface 105.

One of ordinary skill in the art will, however, appreciate that although many of the communications devices listed above incorporate the 2-D image display 115, the 2-D multi-touch-sensing surface 105 and the digital data processor 120 in a common package, each of the elements may be a separate entity and the entities may communicate with each other using a suitable wireless protocol such as, but not limited to, an infra-red or other electromagnetic beam, BlueTooth™, WiFi or some combination thereof. Furthermore, although a device may contain two or more of the elements, it may still be used to communicate with, and control, another of the elements. The touch screen of a smart phone, a tablet, a laptop or an e-reader may, for instance, be used to control a large screen TV, or an overhead projector.

As shown in FIG. 1, the digital data processor 120 may be connected by a data network 230 such as, but not limited to, the Internet, a cable network or a satellite network, or some combination thereof, to a hypertext webpage 225 that may, for instance, contain one or more content elements 175.

The digital data processor 120 may, for instance, be functional to fetch and download one or more downloaded webpages 245. The processor may include a filtering engine 235 that may convert the downloaded webpage 245 into a filtered-webpage 155. This filtering may, for instance, remove unwanted or unnecessary content such as, but not limited to, advertising, images or may reformat the downloaded webpage 245 by altering items such as, but not limited to, font size, white space, table formatting, or some combination thereof.

A rendering engine 240 operable on the digital data processor 120 may then render the filtered-webpage 155 into a virtual web-tile 140 on a virtual framework 135.

The virtual web-tile 140 may, for instance, be an array of pixel values that may, for instance, specify the color, intensity and position of a group of pixels. When the pixels of a virtual web-tile 140 are arranged and displayed as a rectangle having an appropriate ratio of length to breadth, they may form an image that may be representative of the hypertext webpage 225 that was obtained as a downloaded webpage 245. The filtering engine 235 and the rendering engine 240 may, for instance, include suitable algorithms such as, but not limited to, a Gaussian filter, a bi-lateral filter, or a Laplacian filter or some combination thereof, in order to render the hypertext webpage 225 into a virtual web-tile 140 designed to be viewed at one or more different particular magnifications.

The filtering engine 235 and the rendering engine 240 may include algorithms to produce small screen optimized content that may be useful on devices such as smart phones. Small screen optimization may, for instance, include incorporating technology as described in, for instance, U.S. Pat. No. 7,962,522 issued on Jun. 14, 2011 entitled “Flexible, Dynamic Menu-based Web-page Architecture”, the contents of which are hereby incorporated by reference.

In a preferred embodiment, the filtered, rendered websites may be interactive, or live. This may, for instance, be achieved by methods such as, but not limited to, incorporating non-visible pixels that may, for instance, act as formatting or may contain information pertaining to the content such as, but not limited to, links or alternate content. The alternate content may be any suitable audiovisual content. Such content may, for instance, be embedded within the virtual tiles in a pre-rendered, recursive manner such that each level of content may contain both pixels that may be made visible without further rendering, and non-visible pixels that may contain further levels of embedded, pre-rendered content.

The virtual framework 135 may, for instance, be a geometrical layout of the virtual web-tiles 140 both relative to each other and may have values for the absolute and/or relative positioning of the web-tiles with respect to an origin. The virtual framework 135 may, for instance, represent a 2-D grid that may specify the relative positioning and sizing of the virtual web-tiles 140 with respect to each other, and the absolution positioning and size with respect to currently displayed items on a display screen or a reference origin and magnification that may be related to the display screen. This specification may include factors such as, but not limited to, screen position, magnification as a fraction or percentage of display size, transparency of the displayed web-tile, and intensity of display of the web-tile or some combination thereof. In a preferred embodiment, the virtual framework 135 may ensure that the web-tiles do not overlap when displayed on the display screen. A web-tile may appear in more than one location of the virtual framework 135 as it may belong to more than one grouping of related web-sites such as, but not limited to, groupings of news sites, entertainment sites, sports sites, or social sites or some combination thereof. These groupings may be pre-defined or may be user determined or a combination thereof.

A display-map 150 may translate the virtual web-tile 140 into a rectangular array of pixels 160 that may be shown on a particular 2-D image display 115 as a displayed web-tile 190. The display-map 150 may, for instance, interact with the virtual framework 135 and the virtual web-tile 140 to produce physical values that may be interpreted and used by the digital data processor 120 and the 2-D image display 115 to physically display the displayed web-tile 190 so that it may be representative of the original hypertext webpage 225.

The 2-D image display 115 may be any suitable analogue or digital display technology such as, but not limited to, a cathode ray color television (TV) tube, a liquid crystal display (LCD) display, a light emitting display (LED) an organic light emitting diode (OLED) display, a e-Ink display or some combination thereof. In a preferred embodiment, the display may be a suitably compact and light weight flat screen device such as, for instance, a flat screen LED or OLED display as these both have an acceptable spectral range, viewing angle, intensity and efficiency.

The displayed web-tile 190 may be viewed and interacted with by a user. This may, for instance, be done using a 2-D multi-touch-sensing surface 105.

Touch screens may operate using a number of different technologies such as, but not limited to, a mutual capacitance, self-capacitance, surface or projected capacitive, resistive, surface acoustic wave (SAW) technology or infrared technology, or some combination thereof.

In a preferred embodiment, the 2-D multi-touch-sensing surface 105 may be a transparent, mutual capacitive screen that may use indium tin oxide (ITO) as a transparent conductor as such a screen may be overlaid over a display and may simultaneously accept multiple inputs. One of ordinary skill in the art will, however, appreciate that for other uses such as, but not limited to, remote control of a large screen such as a digital TV flat screen via a wireless connection, being transparent may not be necessary or desirable and other touch technologies may be more suitable.

A screen-touch event 130, i.e., the act of a user touching the surface of the 2-D multi-touch-sensing surface 105 in a particular way, may be captured by the screen and recognized by the functionally connected digital data processor 120.

Recognizable finger generated screen-touch events 130 include actions such as, but not limited to, one finger touching, tapping, long touching, gliding and swiping, and two finger touching, two finger taping, two finger long touching, pinching, spreading, swiping and rotating, or some combination thereof.

An interaction interpreter 165 operable on the digital data processor 120 may then interpret the recognized screen-touch event 130 as an instruction. Interpreted user intentions or instructions may include instructions such as, but not limited to, content scrolling, searching, changing magnification, capturing a highlighted element, panning, link sharing, drop sharing or some combination thereof.

In one embodiment of the multi-touch user interface 100 a screen-touch event 130 may, for instance, be recognized as a one-finger glide 180. This may be interpreted as a scroll instruction 405, i.e., and instruction to scroll through the content of a displayed web-tile. The interaction interpreter 165 may then interact with the display-map 150, the virtual web-tile 140 in the virtual framework 135 and the rendering engine 240, and together produce an altered version 220 of the displayed web-tile that now displays one or more different content elements 175, or portions thereof, scrolled in accordance with the scroll instruction 405.

In the same embodiment of the multi-touch user interface 100 when, however, a screen-touch event 130 is recognized as, for instance, a two-finger swipe 205, or two-finger glide, the interaction interpreter 165 may interpret this as, for instance, a pan instruction 410 that may apply to more than one displayed web-tiles 190 currently visible on the image display 115. The result of the display-map 150 interacting with the interaction interpreter 165, the virtual framework 135 and the rendering engine 240 may now result in an altered version 220 that displays the previously visible displayed web-tiles 190 in new positions on the image display 115 but at the same magnification and with the same content elements 175 visible. Depending on the scale of the pan instruction 410, the virtual framework 135 may determine that previously not visible virtual web-tile 140 should now be displayed as displayed web-tile 190, and similarly the virtual framework 135 may determine that previously visible displayed web-tile 190 may now have moved, or been panned, off the display screen and should now be kept as virtual web-tiles 140 and not now displayed as displayed web-tile 190 on the image display 115.

In a preferred embodiment of the present invention, the multi-touch user interface 100 may include at least two different modes of operation. These modes may, for instance, be accessible by a toggle switch that may, for instance, be a physical button that may be ergonomically located on the bottom of the multi-touch-sensing surface 105 for ease of use.

In a first mode of operation, the interaction interpreter 165 may interpret all recognized touch screen event as instructions to be applied to only one displayed web-tile, even if there are multiple web-tiles being displayed.

In the second mode of operation, however, the system may interpret all recognized touch screen events as being instructions to be applied simultaneously to all of the displayed web-tiles.

In the first mode, the instructions may effectively apply to the virtual web-tiles, while in the second mode, they may apply to the virtual framework.

For instance, in the first mode of operation, a one-finger glide may be interpreted as a scroll instruction 405 to be applied to a particular web-tile, whereas in the second mode of operation the same one finger glide may be interpreted as a pan instruction 410.

One of ordinary skill in the art will, however, appreciate that the concept of different interpretations based on modes may be extended to more modes, and may also only apply to a selected subset of recognized touch screen events or gestures. Furthermore, the interpretation may depend on other factors such as, but not limited to, time after start up, position at which the event occurred, and content elements within a web-tile, or some combination thereof.

FIG. 2 shows a flow diagram depicting certain functional steps of a multi-touch user interface of a preferred embodiment of the present invention.

In step 2001, the digital data processor 120 may initiate obtaining a website from a hypertext webpage 225 located at a particular universal resource locator (URL).

In step 2002, the webpage obtained may be filtered and rendered to produce a virtual web-tile that may be an array of pixel values that may be assembled as a graphical representation of the hypertext webpage 225 when arranged in a particular order such as, but not limited to, a rectangle of pre-determined dimensional ratios. The virtual webtile 140 may be stored in, or otherwise associated with, a virtual framework that may represent a relative position of the virtual web-tile to a position on a 2-D image display, or the contents currently displayed on the image display.

In step 2003, the virtual webtile 140 may be displayed on the 2-D image display 115 as a displayed webtile 190. The displayed webtile 190 may, for instance, be a rectangular array of activated display pixels 160 that may be situated at physical positions determined using the display-map 150, the virtual framework 135 and the virtual webtile 140.

In step 2003, the 2-D multi-touch-sensing surface 105 may detect a screen-touch event 130 occurring on the surface of the touch screen. In a preferred embodiment, the touch screen is transparent and may overlay the 2-D image display 115. Alternative embodiments of the invention may, however, have the display and the touch screen located separately and they may interact via suitable wireless links to the digital data processor. Such embodiments may, for instance, be useful in controlling large screen TV displays using a separate device such as, but not limited to, an Apple™ iPad™, a tablet computer, a smart phone or some combination thereof.

Using a screen-map 170 and a interaction interpreter 165 the digital data processor 120 may recognize the screen-touch event as being of a particular type and may then interpret it as an instruction. The screen-map 170 may, for instance, map positions on the 2-D multi-touch-sensing surface 105 to positions in the virtual framework 135 or to positions on the 2-D image display 115, or some combination thereof. The interaction interpreter 165 may run in a variety of modes that may influence the interpretation of recognized screen-touch event. These modes may be user selected or may depend on factors such as, but not limited to, time after start up, time after initial display of the displayed webtile 190, location on the display screen of the webtile, or some combination thereof.

In step 2005, the digital data processor 120 may render an altered version 220 of the web-tiles, and may display that altered version using the display-map 150.

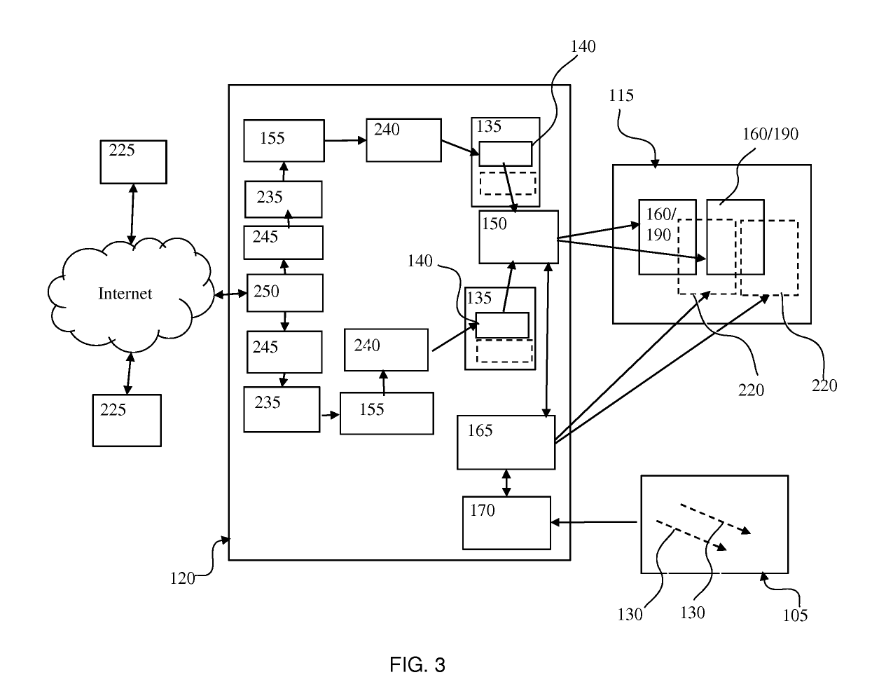

FIG. 3 shows a multi-touch user interface of a further preferred embodiment of the present invention. In this embodiment, the digital data processor 120 may include multiple hardware devices and software elements so as to simultaneously obtain and display multiple hypertext webpages 225.

The system may, for instance, have a caching module 250 that may allow the simultaneous downloading of two or more downloaded webpages 245.

The system may then have multiple filtering engines 235 that may allow the simultaneous filtering of two or more downloaded webpage 245 to produce multiple filtered-webpages 155. Multiple rendering engines 240 may then simultaneously produce multiple virtual webtiles 140. These multiple virtual webtiles 140 may then be stored or associated with one or more virtual frameworks 135.

A display-map 150 may then be used to simultaneously map multiple virtual webtiles 140 to locations on the 2-D image display 115 and make them visible as displayed webtiles 190.

The 2-D multi-touch-sensing surface 105 may then detect multiple simultaneous screen-touch events 130 that may be interpreted using the screen-map 170 and the interaction interpreter 165. This may then interact with the display-map 150 and produce one or more altered versions 220 that may be displayed on the 2-D image display 115.

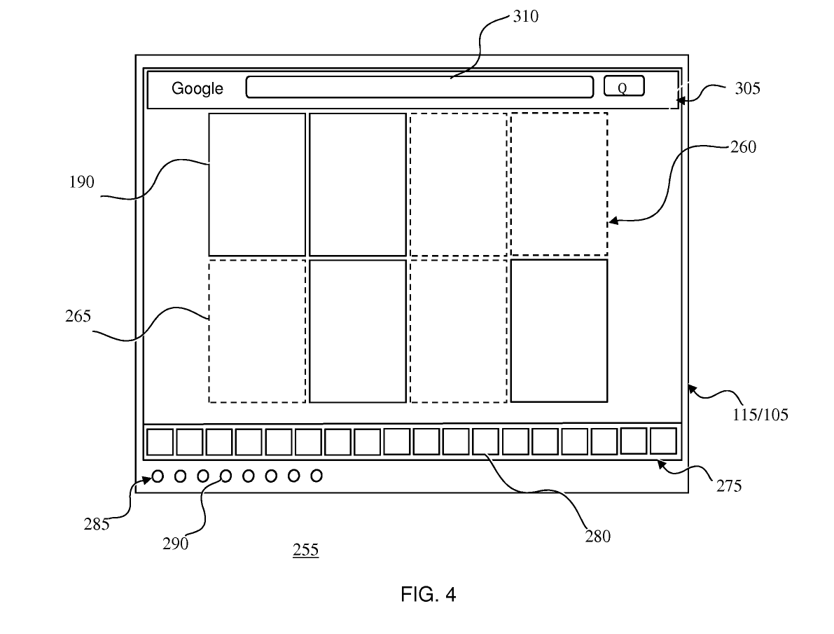

FIG. 4 shows an exemplary screen layout of a multi-touch user interface of the present invention.

The Zuse mode 255 screen layouts may include one or more displayed web-tiles that may be arrayed 260 on the display in a format or positioning that may be determined by a virtual framework, i.e., a virtual map that may include the relative positions of the web-tiles and their absolute position with respect to the display.

The displayed webtiles 190 that are currently active may, for instance, be displayed at a higher intensity or opacity, or both to distinguish them from currently inactive web-site 265 that may be displayed at a visibly lower intensity or with visibly less opacity (greater transparency) than the currently active web-tiles.

The screen layout 255 may also include a search strip 305 that may be optionally temporarily hidden. The search strip 305 may, for instance, include a query entry space 310.

Another feature that may be displayed may be the ribbon of website icons 275. This may be scrollable. Using a suitable screen-touch event 130 that may be interpreted as a icon load instruction 415 may allow a user to select an icon representative of a page or site URL, and cause that page of site to be loaded into a selected displayed webtile. For instance, a user one-finger touching an icon on the ribbon and then using a using a one-finger glide to traverse a path on the surface of the touch screen to within a current location of a displayed web-tile 190, that may be currently active or inactive, may cause the selected web-page to be displayed in that web-tile. The new web-page may, for instance, replace the currently displayed the web-site.

In a preferred embodiment, the architecture of the system may be such that the digital data processor 120 begins loading the selected web-page into cache as soon as the user touches the icon. By the time the user one-finger glides to a selected web-tile, the page may already be downloaded, filtered and rendered ready for displayed. In this may the appearance in the web-tile of the new web-page may be made to appear instantaneous to the user, i.e., as soon as they glide into and stop on the web-tile, the new page may appear.

One of ordinary skill in the art will, however, appreciate that the screen-touch events that may be interpreted as an icon load instruction may be varied. One alternate that may also be considered intuitive may, for instance, be for the user to simultaneously long touch an icon on the ribbon and a location of a displayed webtile 190 using a finger and a thumb. This may, for instance, create the illusion of the web-page flowing from the selected icon to the selected web-tile through the user's hand.

There may also be a screen-touch event that may be interpreted to have the opposite effect. By, for instance, long-touching a web-tile and then one-finger gliding to a location of an icon on the ribbon, or a vacant location on the ribbon, an icon representative of the site may be loaded into the ribbon along with the appropriate URL for future location of the web-page.

In addition to the items displayed on the display screen, the user device may have an array of action buttons 285 that may be physical buttons. The action buttons 285 are preferably located so as to be easily reached by the thumb of the hand of a person holding the device. Such ergonomic placing of fixed buttons may facilitate quick, comfortable and less tiring use of the device. The device may also be available in left or right hand options, each with the array of action buttons 285 on the opposite lower edge of the device.

The action buttons 290 may for instance, facilitate switching between the interpretation modes detailed above.

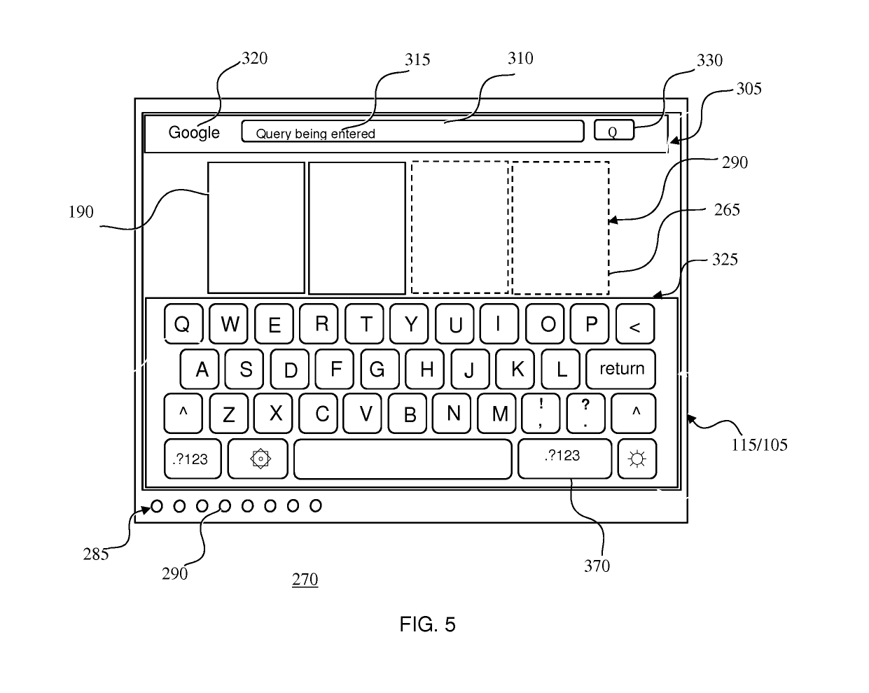

FIG. 5 shows a further exemplary screen layout of a multi-touch user interface of the present invention in what may be designated the “URL alpha-numeric entry” mode 270.

In FIG. 5, one of the action buttons 290 on the array of action buttons 285 may have been used to invoke a virtual keyboard 325. The virtual keyboard 325 may, for instance, be laid out as a conventional Qwerty screen and may have sensitive regions that produce input similar to a conventional, physical keyboard. The virtual keyboard 325 may be useful in entering text based search requests.

In FIG. 5, the query entry space 310 on the search strip 305 is shown being populated by an alpha-numeric search string 315 as the 2-D multi-touch-sensing surface 105 above the keys on the virtual keyboard 325 displayed on the 2-D image display 115 are one finger tapped in order.

Once the search string 315 has been entered, the “go search” virtual button 330 may be activated by a touch-event and the search conducted. The default search engine 320 may be used for the search and the results displayed in a preselected displayed webtile 190.

Alternately, a “TapSearch” mode may be used. In this, a user may select two or more search engines and load each into a different web-tile. The search entered in the query entry space 310 may now be conducted simultaneously across all selected search engines and the results displayed simultaneously in co-displayed web-tiles.

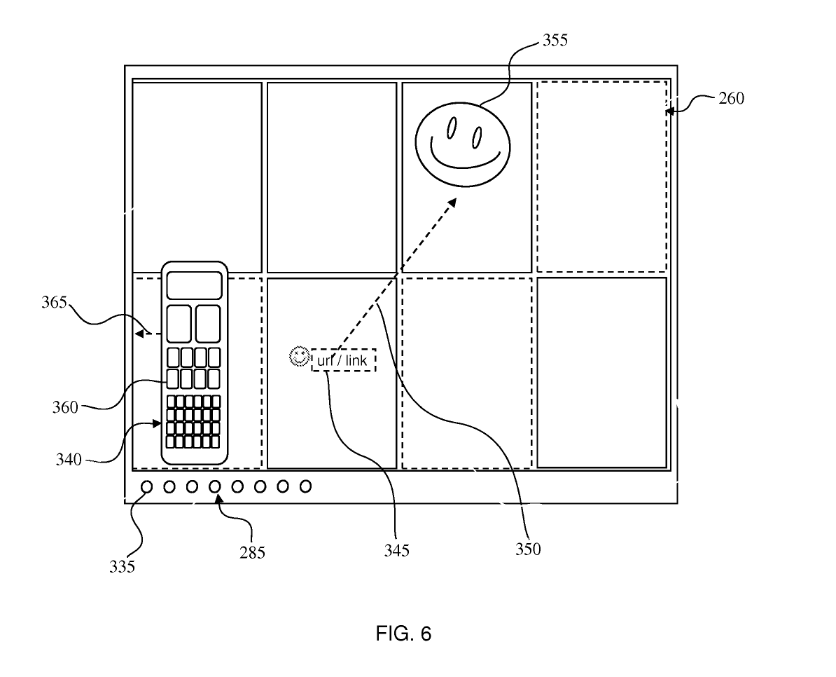

FIG. 6 shows yet a further exemplary screen layout of a multi-touch user interface of the present invention. As shown previously, the screen layout may display web-tiles arrayed 260 in a format or positioning that may be determined by a virtual framework.

FIG. 6 is intended to illustrate, among other items, a drag and share function, a drop share function and a rapid zoom function.

The rapid zoom function may, for instance, be activated by a quick zoom button 335 that may be situated on the array of action buttons 285. Pressing the quick zoom button 335 may, for instance, instantiate an image of a quick zoom icon 340 on the display screen. The quick zoom icon 340 may, for instance, include one or more quick zoom levels 360, each of which may have a graphic showing a number of screens. By selecting on of the quick zoom level 360 by a suitable screen-touch event 130 a user may select to immediately switch to displaying the illustrated number of web-tiles on the display screen. Once the desired quick zoom level has been selected, a user may make a screen-touch event 130 that may be interpreted as a “close” swipe 365. For instance, by one finger long touching the quick zoom icon 340 and then one-finger gliding to the edge of the display screen, the user may cause the quick zoom icon 340 to cease being displayed.

A “drag and share” function may, for instance, make use of a URL 345 that may be displayed as content in a web-tile. By a suitable screen-touch event 130 a user may initiate a “link drag” instruction 350. The “link drag” instruction 350 may, for instance, cause a web-page accessible via the URL to be displayed in selected web-tile as a rendered, filtered website at dragged link 355.

A suitable screen-touch event 130 that may be interpreted as a “link drag” instruction 350 may, for instance, be a one-finger long touch on the URL link, followed by a one-finger glide to the selected web-tile. As the URL may begin being cached as soon as long-touching the URL begins, the web-page may be ready for loading by the time the glide to the web-tile is completed, allowing the new page to be displayed immediately, giving the impression of instantaneous loading of the web-page.

An alternate screen-touch event 130 that may be suitable to invoke a “link drag” instruction 350 may be for a user to one-thumb long touch the URL, and then to simultaneously long touch one or more web-tiles with one or more fingers, thereby loading the web-page into those selected active or inactive web-tiles.

A “drop share” instruction 352 may, for instance, be used with one or more social sites and may be initiated using screen-touch events 130 similar to those used for the “link drag” instruction 350 as detailed above. The same screen-touch events 130 may even be used if they are made while the system is in a different interpretation mode.

One objective of a “drop share” instruction 352 may be to share a URL with multiple friends on a social website, or to share a URL with friends on multiple websites.

Other functions and features that may be included in one or more embodiments of The present invention include, but are not limited to, grouping web-sites by labels such as “News”, “Social”, “Shopping”, “Sports”, “Work project 1”, “Financial”, “Family” or some combination thereof. In this way related web-sites may occupy adjacent positions in the virtual framework 135 so that they may be displayed together, and may be accessed as a group.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A multi-touch user interface, comprising:
A 2-D image display;
A 2-D multi-touch-sensing surface functionally connected to said 2-D image display;
a digital data processor functionally connected to both said 2-D image display and said 2-D multi-touch-sensing surface, said digital data processor programed via a set of instructions to provide functionality comprising:
maintaining a virtual framework comprising at least one virtual web-tile, said virtual web-tile being representative of an array of pixels;
rendering a filtered-webpage to one of said virtual web-tiles associated with said virtual framework;
maintaining a display-map having instructions mapping said virtual web-tiles to a rectangular array of pixels on said 2-D image display;
displaying said web-tile comprising said rendered, filtered-webpage on said 2-D display as a displayed web-tile;
capturing a screen-touch event occurring on said 2-D multi-touch-sensing surface 105;
recognizing said screen-touch even;
interpreting said recognized touch screen event as a first type of user-screen interaction;
rendering an altered version of said displayed web-tile using a screen-map having instructions mapping said touch screen to said virtual framework; and
displaying said altered version of said displayed web-tiles on said 2-D display.

2. The multi-touch user interface method of claim 1 wherein said interpreting said screen-touch event 130 further comprises using a content element of said filtered-webpage.

3. The multi-touch user interface method of claim 2 wherein said first type of user-screen event is a one-finger glide and is interpreted as a scroll user-touch-interaction and said altered version of said displayed web-tiles comprises scrolling a content element displayed in one of said displayed web-tiles.

4. The multi-touch user interface method of claim 3 wherein said virtual framework comprises at least two web-tiles, said web-tiles being mapped to adjacent rectangular arrays of pixels on said 2-D image display, each array being of the same size; and wherein said method further comprises:
rendering one of said filtered webpages to each of said web-tiles;
simultaneously displaying said at least two web-tiles on said 2-D display;
capturing one of said screen-touch events;
recognizing said captured screen-touch event as a two-finger swipe;
interpreting said two-finger swipe as a pan user-touch-interaction;
and said altered version 220 of said displayed web-tiles comprises panning said displayed web-tiles across said 2-D display.

5. The multi-touch user interface method of claim 4 further comprising at least one icon-tile array of pixels, said icon-tile array being indicative of a webpage URL and wherein said multi-touch user interface method further comprises:
displaying said icon-tile on said display screen;
capturing and interpreting one of said touch-screen events as an icon-touch-and-slide-to-a-displayed-web-tile interaction; and
said altered version of said displayed web-tiles comprises substituting a rendered filtered webpage located at said webpage URL into said slid-to displayed web-tile.

6. The multi-touch user interface method of claim 1 wherein said virtual framework comprises at least two web-tiles, said web-tiles being mapped to adjacent rectangular arrays of pixels on said 2-D image display, each array being of the same size; and wherein said method further comprises:
rendering one of said filtered webpages to each of said web-tiles;
simultaneously displaying said at least two web-tiles on said 2-D display;
capturing one of said screen-touch events; and
recognizing said captured event as one selected from the set of interactions comprising one finger tapping, long touching, glide and swiping, and two finger tapping, two finger long touching, pinching, spreading, swiping and rotating.

7. The multi-touch user interface method of claim 1 wherein said virtual framework comprises at least two web-tiles, said web-tiles being mapped to adjacent rectangular arrays of pixels on said 2D image display, each array being of the same size; and wherein said method further comprises:
rendering one of said filtered webpages to each of said web-tiles;
simultaneously displaying said at least two web-tiles on said 2-D display;
providing a mode toggle button that switches between a first mode and a second mode; and,
if said system is in said first mode, interpreting said recognized touch screen event as an instruction to be applied to one of said displayed web-tiles; else
if said system is in said second mode, interpreting said recognized touch screen event as an instruction to be applied simultaneously to both of said web-tiles.

8. The multi-touch user interface method of claim 7 wherein said recognized touch screen event is a one-finger glide; and
if said system is in said first mode, interpreting said recognized touch screen event as a scroll instruction and said altered version 220 of said displayed web-tiles comprises scrolling at least one content element displayed in one of said displayed web-tiles; else
if said system is in said second mode, interpreting said recognized touch screen event as a pan instruction and said altered version of said displayed web-tiles comprises panning said displayed web-tiles across said 2-D display.
